(19) United States
(12) Patent Application Publication
(10) Pub. No.: US 2001/0014611 A1
(43) Pub. Date: Aug. 16, 2001

(54) SYSTEMS AND METHODS FOR DISPATCHING OVER FREQUENCY REUSE NETWORKS

(76) Inventor: JAMES R. DUFORT, DURHAM, NC (US)

Correspondence Address: MR. TED NANZ, READYCOM, INC., 2525 MERIDIAN PARKWAY, SUITE 300, DURHAM,, NC, 27713, US

(21) Appl. No.: 09/140,777

(22) Filed: Aug. 26, 1998

(51) Int. Cl. H04Q 7/00

(52) U.S. Cl. 455/517; 455/446; 340/7.21

(57) ABSTRACT

The present invention allows a personal computer to be used as a wireless device. The dispatcher system allows the dispatcher to record messages and confirm delivery of the message to the appropriate field agent. The dispatcher system also alerts the dispatcher of an incoming message transmitted from the field agents to the dispatcher. After the dispatcher is alerted, he can listen to the message and compose a reply message to be sent to the field agent responsible for transmitting the incoming message. The system works very efficiently in that messages are forwarded from the dispatcher system in the mobile service provider format such that delay and errors caused by translation from one format to another are eliminated.

### FIELD OF THE INVENTION

The present invention relates to systems and methods for creating and then forwarding voice messages to a network which then transmits the voice messages to one or a plurality of remote communication devices.

### BACKGROUND OF THE INVENTION

One application for a mobile communication system is the transmission and reception of a plurality of messages between a single dispatcher and a single field agent. A problem experienced in this type of system is the fact that the dispatcher is typically located at a desk within a building. This makes it difficult, if not impossible, for the dispatcher to use wireless communication devices due to the interference created by the building.

In this scenario, the dispatcher is required to use a land line or a Plain Old Telephone Service (POTS) line. The dispatcher's message is first produced in an analog format by his telephone, which is transmitted as an analog signal to a wireless transmitter/receiver where it is converted into a format suitable for wireless transmission. The dispatcher's message is then transmitted to the appropriate field agent.

While this system is efficient, it can suffer from delays and errors. First, the analog transmission through the Public Switched Telephone Network (PSTN) does introduce noise into the analog message signal. This noise will be incorporated into the converted signal before it is transmitted to the field agent making the signal received by the field agent more noisy.

In addition, this system only allows the dispatcher to reach one field agent at a time via his telephone. Should the dispatcher need to send the same message to a plurality of field agents, he will need to dial the plurality of numbers and repeat the message for each field agent. The labor in dialing the plurality of numbers along with the amount of time needed to reach all of the field agents with a needed message grows as the number of field agents he needs to contact grows.

The length of time to reach each field agent becomes even more of a problem when time is of the essence. Such a scenario may require a dispatcher to inform ten or more field agents that a certain computer will be going off-line in fifteen minutes for over an hour. Such a message would be particularly important to the field operators as they may be in the middle of an exercise which requires the computer and would need to know to save their work in its present state, log off and return to the project later when the computer is back on-line.

Another problem with transmitting a message to a plurality of field operators is consistency. If a dispatcher must transmit the same message to a plurality of field operators, there is the distinct possibility that each message to each field operator will be slightly different. If time is of the essence, there is a higher probability of the dispatcher forgetting an important part of the message to a particular field operator in an effort to get the message out quickly.

The dispatcher must also receive messages from the field agents. As mentioned above, he cannot use his wireless device due to interference from the building. Once again, the field agents must have their wireless signals converted into an analog phone format before they can be forwarded to the dispatcher's phone. Again this introduces possible errors as the signals must be converted.

U.S. Pat. No. 4,942,598 issued to Davis discloses an answering machine that answers incoming phone calls and either forwards the message to a pager, records the messages for forwarding to a pager later, terminates the call or forwards the call to another phone number. The decision of what to do with any particular incoming call is based on decoding the Automatic Number Identification (ANI) data. A microcomputer reads a ROM and compares the data therein to the ANI provided to the microcomputer by a telephone network and then processes the incoming call accordingly. This answering machine is limited in that it is only an answering machine. A user cannot use this answering machine to create messages to be sent to remote communications devices. Additionally, Davis' answering machine is a special stand-alone machine and is therefore another piece of equipment which must be bought by the user rather than being integrated into an existing personal computer.

U.S. Pat. No. 4,961,216 issued to Baehr et al. discloses a telephone answering and paging system where the caller places a voice message along with tag information relating to the urgency of the call. This system is an answering and forwarding system which itself cannot be used to create messages to be sent to others. A user of the Baehr et al. system would still need a telephone or communication device separate from the answering and forwarding system in order to get in contact with other people.

U.S. Pat. No. 4,994,797 issued to Breeden discloses a system which adds tag information to a received message. Breeden's system cannot itself be used to generate messages to be sent to other people over a network. Thus, a user of Breeden's system would still need to have some form a communication device in order to leave a messages with another person.

U.S. Pat. No. 5,003,576 issued to Helferich discloses a device for storing incoming phone messages. However, Helferich does not provide any method for using the device to generate messages or alert a user when a message has been received. Therefore, anyone using Helferich's system would still need an additional communication device in order to reach other people and inform the user when he has received a new message.

U.S. Pat. No. 5,281,962 issued to Vanden Heuvel et al. discloses a system which generates tag data indicative of the data being received by the system. This system, however, cannot be used to generate messages which are to be transmitted to other people. Therefore, a user of the this system would still need to have an additional communication device in order to generate messages for forwarding to other people.

U.S. Pat. No. 5,327,486 issued to Wolff et al. discloses the establishment of communications between a caller and another person via the other person's palm top computer. This system suffers from the additional processing time and expense of translating messages from text to audio signals and vice versa. Therefore a customizable reply will need to use this expensive software in order to translate a text message from a palm top computer into a voice based message for the caller. While Wolf et al. do describe a database of most used responses and a certain level of customizing those most used responses, Wolf et al.'s system does not allow for quick, easy and fully customizable responses from the called party without the need for using expensive software. Wolf et al's system also does not allow the other person to send a message to another via the palm top computer.

### SUMMARY OF THE INVENTION

The present invention is designed to overcome the deficiencies noted above. In particular, the present invention gives a dispatcher a simple and effective system and method for transmitting messages to a plurality of field operators very easily. The present invention also allows the plurality of field operators to transmit messages to the dispatcher.

In accordance with an embodiment of the present invention, a dispatcher is able to transmit and receive messages via a telephone line coupled to a personal computer (PC). This eliminates the need for the dispatcher to have a wireless device which may be interfered with by the structure of the building the dispatcher is sitting in.

In accordance with another embodiment of the present invention, a dispatcher system is disclosed which contains a central processing unit (CPU) and a memory which are connected to a telephone line so that the CPU and memory may receive and transmit messages from a telephone line which is coupled to a PSTN. The messages are forwarded to field agents via a wireless transmitter/receiver coupled to the PSTN. This system also allows for field agents to send messages via the wireless transmitter/receiver and the PSTN to the dispatching system.

In accordance with another embodiment of the present invention, a dispatcher system forwards a message to a field agent or a plurality of field agents by either recording a message from a dispatcher or selecting a previously recorded message, storing the message in a memory, establishing a link between the central dispatching system and a mobile communications device, forwarding the message to the mobile communications link via the established link, and storing the message in a second memory within the mobile communications device.

These advantages and others are apparent from the non-limiting detailed description of embodiments of the present invention.

### BRIEF DESCRIPTION OF THE DRAWINGS

The accompanying drawings, which are incorporated in and form a part of the specification, illustrate preferred embodiments of the present invention and, together with the description, disclose the principles of the invention.

FIG. 1 is a diagram of a system according to an embodiment of the present invention.

FIG. 2 is a block diagram of an embodiment of a dispatcher system in accordance with the present invention.

FIGS. 3a and 3b are flow charts showing the processes for creating new messages and replying to field agent messages at the dispatcher system in accordance with the present invention.

FIG. 4 is a flow chart which shows the process for receiving a message at the dispatcher system in accordance with the present invention.

FIG. 5 is a flow chart which shows the initiation of certain processes performed by the dispatcher system in accordance with the present invention.

### DETAILED DESCRIPTION OF THE PREFERRED EMBODIMENTS

I. System Overview

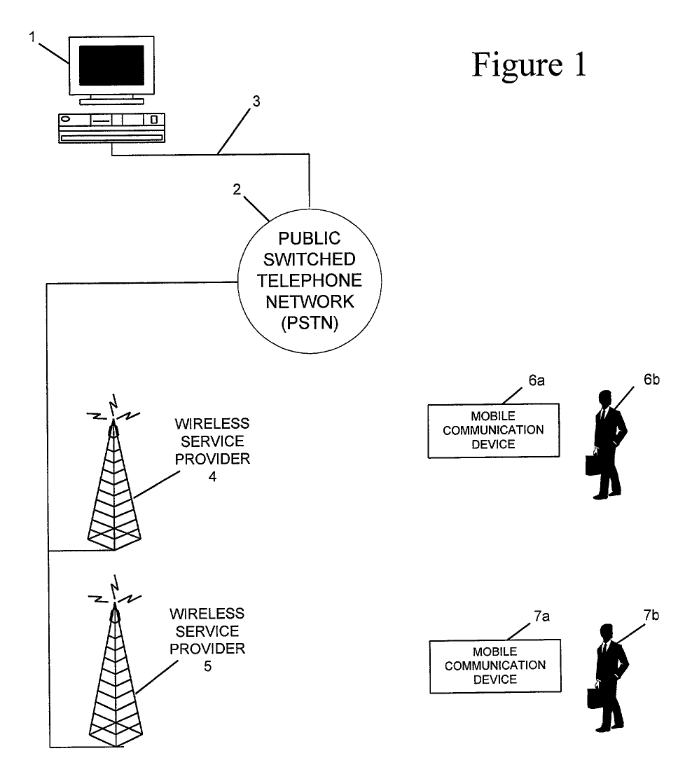

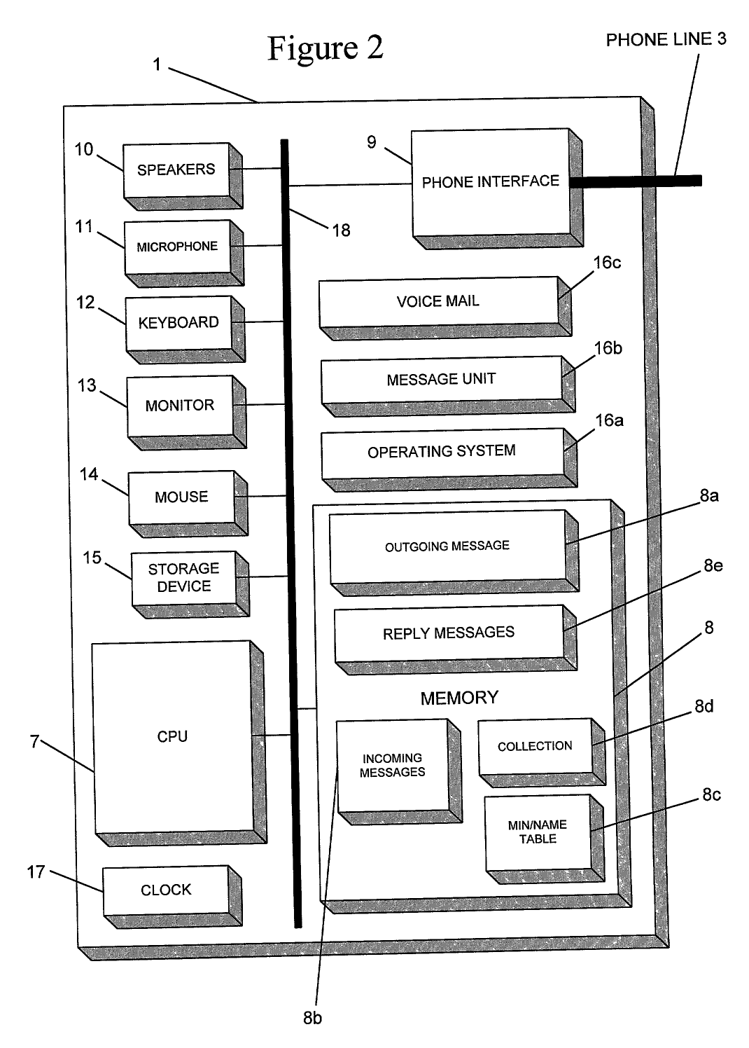

Reference will now be made in detail to preferred embodiments of the invention via illustrations and descriptions of non-limiting examples. FIG. 1 illustrates an embodiment of the present invention. It includes a dispatcher system 1 which communicates with a plurality of field agents 6b and 7b. The dispatcher system 1 contains a telephone interface (shown in FIG. 2) which is coupled to a telephone land line 3. The field agents receive and transmit messages via their respective mobile communication devices 6a and 7a.

The dispatcher system 1 receives and outputs voice messages through its telephone land line 3 and a telephone interface (shown in FIG. 2). The telephone land line is coupled to the Public Switched Telephone Network (PSTN) 2. The PSTN 2 is coupled to one or more wireless service providers 4 and 5 which are used to transmit and receive signals via wireless links to mobile communication devices 6a and 7a.

FIG. 2 is a detailed drawing of the dispatcher system 1 according to the present invention. Dispatcher system 1 is made up of CPU 7 which executes all of the software and controls the data flow among the other elements. Memory 8 holds the data and the messages of the dispatcher system 1. An operating system 16a controls the CPU 7. The operating system 16a, message unit 16b and the voice mail unit 16c all interact with each other so as to properly receive, record and forward messages to and from field agents. Voice mail unit 16c controls a telephone interface 9, which is coupled to phone line 3, and works along with the message unit 16b in the way data, such as messages, is organized in memory 8.

As stated before, memory 8 holds data. The outgoing messages that are recorded by the dispatcher are stored in outgoing message memory 8a. This is the message the dispatcher intends to transmit to a field agent via the field agent's mobile communication device 6a or 7a. Storage location 8b holds the incoming messages transmitted to the dispatcher system 1 from various field agents 6b and 7b. Table 8c holds the names of field agents and their corresponding Mobile Identification Numbers (MINs). Prerecorded reply messages are stored in memory section 8e. Data transfers into and out of memory 8 are controlled by the executable software 16a-16c.

In addition, the memory 8 houses an additional memory section called the collection 8d. The collection 8d is used to access specific entries in the MIN/Name table 8c as is described in more detail later.

Dispatcher system 1 also contains a microphone 11 and speakers 10. These are controlled by the CPU 7 and the operating system 16a, the voice mail unit 16c and the message unit 16b. The user uses the speakers 10 to hear messages and the microphone 11 to record the reply messages and the dispatcher originated outgoing messages.

The user inputs data via a keyboard 12 and receives visual data via a monitor 13. The user may also use a mouse 14, or some other device which responds to motion to move a cursor on a monitor 13 to make data input selections such as a touch pad or a track ball.

The dispatcher system 1 also contains additional storage 15. This additional storage could be a hard drive, a floppy drive, a CD-ROM, a writeable CD-ROM, magnetic tape, RAM or ROM. The storage device 15 stores data, such as the outgoing messages and MIN/Name table, so that the memory 8 may be refreshed with this data upon power-up or rebooting.

The dispatcher system 1 also contains a clock 17 which is used to synchronize all of the components. Bus structure 18 interconnects all of the various elements. It should be noted that the clock 17 may integrated onto the CPU 7 and the bus structure 18 may be a single bus design or a bus design comprised of a plurality of sub-bus structures interconnecting specific elements.

The dispatcher system 1 may be implemented on a PC or other computer which allows a user to take advantage of the features of the present invention. In the preferred embodiment of the dispatcher system 1, the CPU 7 is a PENTIUM™ processor, the operating system 16a is Windows 95™, the storage device 15 is a 2 Gbyte hard drive, and the dispatcher system 1 has at least 32 Mbytes of RAM. In addition, in the preferred embodiment, the voice mail unit is either a telephony card or a modem with voice mail capabilities, although the software package TAPI™, developed by Microsoft™, may also be used as part of the voice mail unit 16c.

II. Messages Dispatch

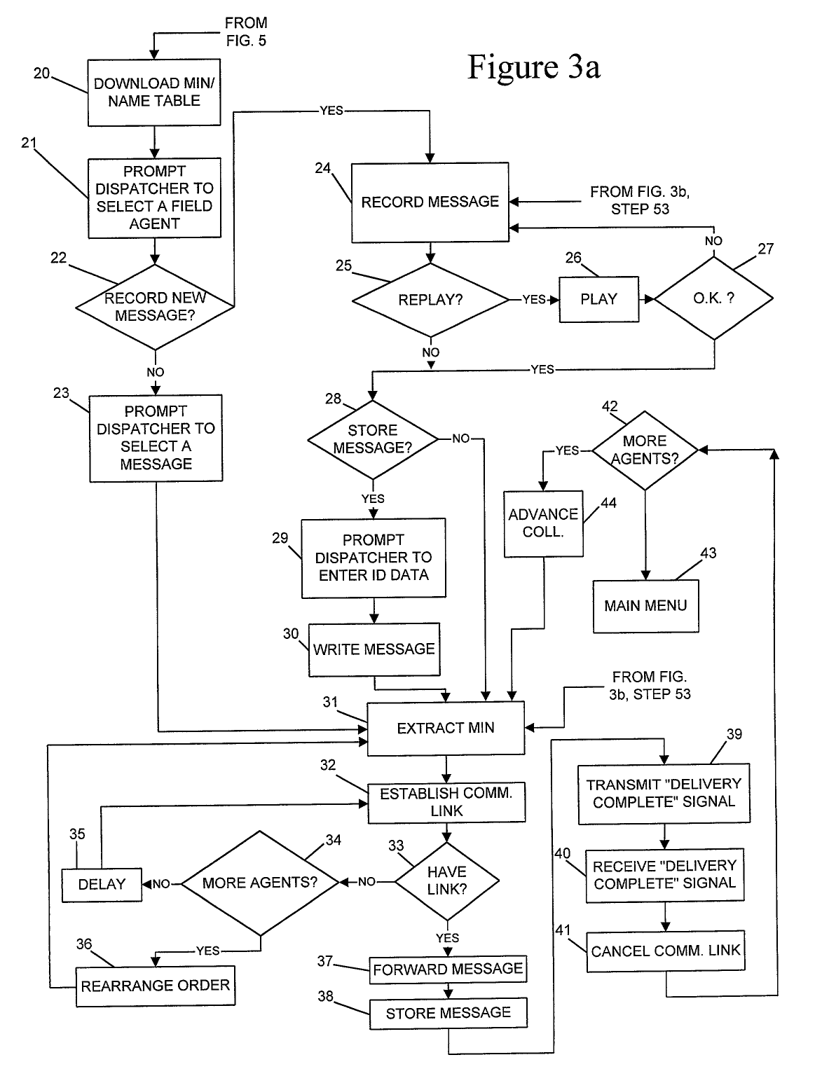

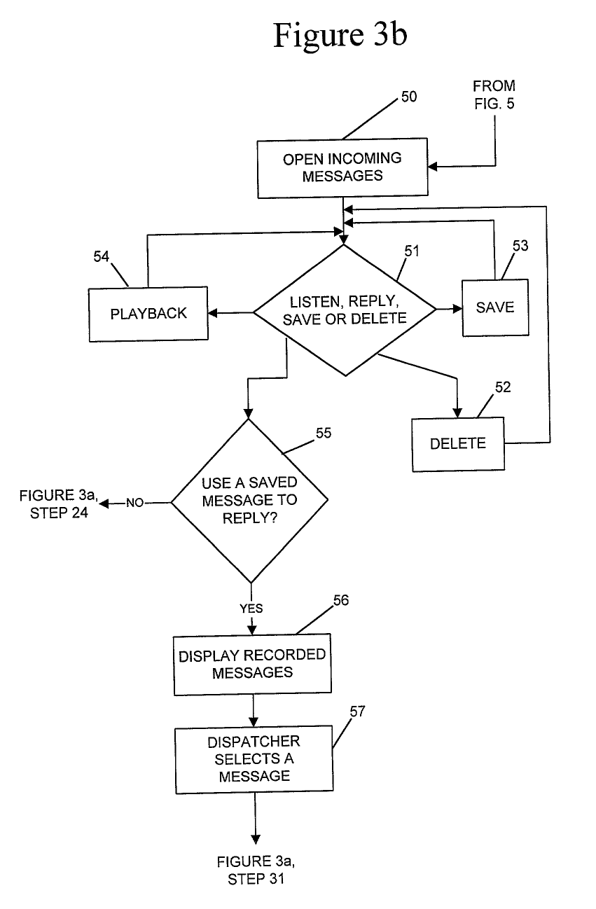

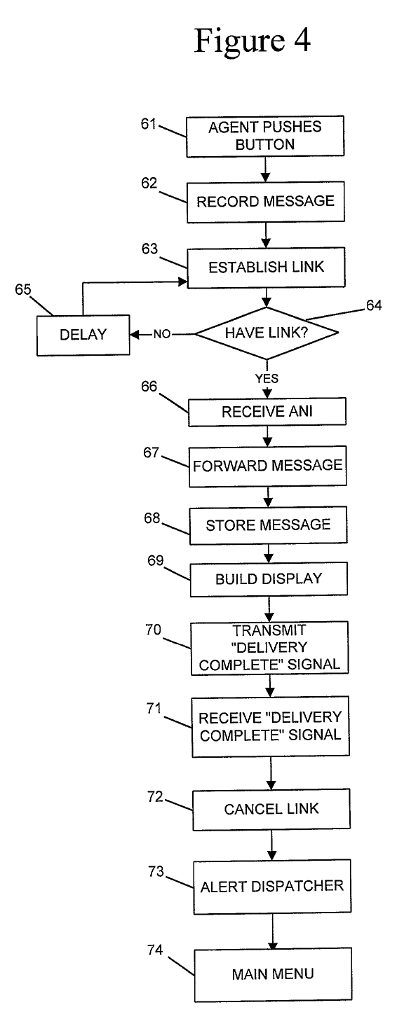

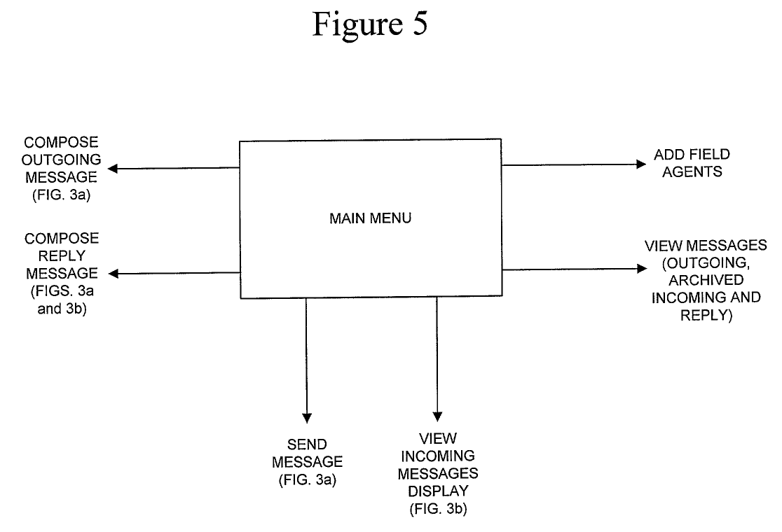

FIGS. 3a and 3b show steps the dispatcher system 1 follows when transmitting an original message or when replying to a received message. When the dispatcher is sitting in front of the dispatcher system 1, he inputs data and this invokes the message unit 16b and this is described later in conjunction with FIG. 5. After the message unit 16b is invoked, the storage device 15 downloads the MIN/Name table 8c into memory 8 at step 20. This way, the various applications will have quick access to the names and phone numbers of the various field agents. The dispatcher is then prompted by the dispatcher system 1 to select a field agent at step 21. The dispatcher responds by either selecting one or more field agents from a list shown on the monitor using the mouse 14 or by entering one or more field agent's MIN directly via the keyboard at step 21. Should the dispatcher select more than one field agent, the dispatcher system 1 creates a collection 8d which represents the order in which the field agents will be sent the message. One example of a collection 8d is an array of pointers to the MIN/Name table 8c. Thus, at step 21, and pointer values associated with each MIN/Name value are inserted into the collection 8d to provide access to each MIN/Name value in the MIN/Name table 8c.

At step 22, the dispatcher system 1 prompts the dispatcher on whether he wishes to record a new message. If the dispatcher answers “No,” the dispatcher system 1 provides a list of stored messages at step 23. This list appears on the monitor 13 and generally is a list of messages organized by title or date recorded. This display also includes other information such as the composer of the message, a brief description of the content of the message as well as the size of the message. At step 23, the dispatcher selects the appropriate message via either the mouse 14 or the keyboard 12.

If at step 22, the dispatcher answers “Yes”, the dispatcher system 1 uses the voice mail unit 16c to record the outgoing message at step 24. This message is originated by the dispatcher and is different from a reply to a field agent originated message. The recorded message is stored in the outgoing message section 8a of memory 8.

After the message is recorded, the dispatcher system 1 queries the dispatcher to determine if he wishes to hear the message at step 25. If the dispatcher wishes to hear the message, he inputs a “Yes” answer via either the keyboard 12 or the mouse 14. In response to the “Yes” answer, the dispatcher system 1 plays back the message at step 26 and then prompts the dispatcher at step 27 regarding the dispatcher's satisfaction with the message (i.e. “Is The Message O.K.?”). If the dispatcher does not like the message, he enters a “No” answer via the keyboard 12 or the mouse 14 and the dispatcher system 1 records a new message at step 24.

If the dispatcher is satisfied with the message at step 27, or chooses not to listen to the message at step 25, the dispatcher system 1 then prompts the dispatcher at step 28 regarding his desire to save the message for future use. If the dispatcher answers “No,” the dispatcher system 1 extracts the appropriate MIN at step 31. If the dispatcher answers “Yes” at step 28 the dispatcher system 1 displays the list of previously recorded and saved messages, much like the one displayed in step 23, and prompts the dispatcher to enter identifying data (i.e. a title, description and composer) describing the recorded message to be saved at step 29. After the dispatcher enters the identifying data at step 29, the dispatcher system 1 writes the recorded message onto the storage device 15.

After either 1) saving the recorded message onto the storage device 15 at step 30, or 2) not saving the recorded message onto the storage device at step 28, or 3) having the dispatcher select a previous recorded message at step 23, the dispatcher system 1 extracts the needed MIN for the first selected field agent's mobile communications device at step 31. This MIN extraction step 31 involves either reading the appropriate MIN value from the MIN/Name table 8c when the dispatcher is originating the message (i.e. either recording a new message or reusing a saved message) or extracting the name of the field agent from a field agent's initial message if the dispatcher is reviewing the list of incoming messages he has received which is described in more detail below.

After the appropriate MIN has been extracted, the dispatcher system 1 attempts to establish a communication link between itself and the mobile communication device via the PSTN 2 and the appropriate wireless service provider 4 or 5 at step 32. At step 33, the dispatcher system 1 determines if a link has been established. If a communications link has not been established, perhaps due to the desired mobile communications device receiving another message at that moment, the dispatcher system 1 checks if there are more field agents who have not yet received the message at step 34. If the dispatcher system 1 determines that there are more field agents who have yet to receive this message, the dispatcher system 1 reorders the collection 8d at step 36 and then tries to forward the message to the next field agent by extracting his MIN from the MIN/Name table at step 31. If the dispatcher system 1 determines that this is either the only or last field agent yet to receive the message, it will wait some amount of time, such as a default value determined at the time of manufacture or a value selected by the dispatcher at step 35 and then try to establish a communications link at step 32.

Once a communications link is established, the dispatcher system 1 forwards the message over the PSTN 2 and appropriate wireless service provider station 4 or 5 to the selected mobile communications device at step 37 and removes that field agent's corresponding data from the collection 8d so as to avoid sending him the same message twice. In one embodiment of the invention, the format of the message forwarded over the PSTN 2 to the wireless service 4 or 5 is in a format the wireless service 4 or 5 readily understands and uses. Thus, the message is transmitted in the format suitable to the wireless service the message is going to such that conversions are not needed and the message may be directly transmitted to the appropriate communication device 6a or 7a. For example, the assignee of the present invention, ReadyCom, Inc., has a protocol for messages transmitted over its systems. The dispatcher system 1 dispatches the messages in this format when the message is being forwarded to a user of the ReadyCom, Inc. system.

At step 38, the field agent's mobile communication device stores the dispatcher's message. After the mobile communications device has stored the message, it transmits a signal back to the dispatcher system 1 indicating that the message has been received at step 39.

At step 40, the dispatcher system 1 receives the message delivery confirmation signal and alerts the dispatcher that the message has been received by an audio signal sent through the speakers 10, a visual signal sent to the monitor 13, or both. Upon reception of the “Delivery Complete” signal, the dispatcher system 1 cancels the communication link (i. e. hangs-up) at step 41.

At step 42, the dispatcher system 1 checks to see if there are more field agents in the collection 8d who have not yet received the dispatcher's message. If the dispatcher system 1 determines there are more field agents yet to receive the message, it will advance to the next data point in the collection at step 44 so as to gain access to the following MIN value in the MIN/Name table 8c. Once the next MIN value is accessible in the MIN/Name table 8c, the dispatcher system 1 extracts that field agent's MIN from the MIN/Name table 8c at step 31.

If at step 42 the dispatcher system 1 determines there are no more field agents selected to receive the dispatcher's message, the dispatcher system 1 enters a WAIT state at step 43. It should be noted that upon entering the WAIT state 43, the dispatcher system 1 effectively erases the recorded outgoing message by denying access to it to the dispatcher. In other words, the dispatcher cannot now decide to send the message to another field agent without going back to the beginning step 20.

III. Dispatcher Sends A Reply Message

Reply messages from the dispatcher are generated in a similar but somewhat different manner from that just described. The process of sending reply messages is shown in FIG. 3b. At step 50, the dispatcher executes an application which displays all of the incoming messages. Typically, the display includes the day and time the message was received at the dispatcher system 1 as well as the field agent's name and MIN who sent the message. The display is generated by reading the information within the incoming messages section of memory 8b. It should be noted that incoming message section of memory 8b may contain zero, one or a plurality of messages and the display shown to the dispatcher in step 50 will reflect those conditions. From this display, the dispatcher has four choices. He may listen to the message, reply to the message, save the message, or delete the message.

Next, the dispatcher decides what he wants to do at step 51. First the dispatcher will select a displayed message via either the keyboard 12 or the mouse 14 at step 51. The dispatcher then may select to delete the message by making the appropriate entry at step 52. In response, the dispatcher system 1 erases the message from the incoming messages section 8b of the memory 8 and causes the display to readjust so as to no longer display that particular message.

Instead of the deleting the incoming message, the dispatcher may decide to archive the message. After selecting a particular message from the display, the dispatcher then activates the save function at step 53 and, in response, the dispatcher system 1 writes the incoming message to the storage device 15. After writing the message to the storage device 15, the dispatcher system 1 readjusts the display so as to remove this message and waits for another dispatcher input at step 51.

Instead of saving the incoming message, the dispatcher may decide to listen to the message. After selecting a particular message from the display, the dispatcher then activates the playback function at step 54 and, in response, the dispatcher system 1 replays the message. After playing the message, the dispatching system 1 waits for another dispatcher input at step 51. In this manner, the dispatcher may listen to a message and then either save it or delete it in accordance with the processes described above.

The final selection a dispatcher may make with respect to a message is to reply to it. At step 51, the dispatcher selects a message and selects the reply function. At step 55, the dispatcher decides on whether or not he will use a pre-recorded reply message or generate a new, custom made reply. If at step 55 the dispatcher decides to use a pre-recorded reply message, he makes the appropriate selection at step 55 and the dispatcher system 1 displays all of the available reply messages at step 56. Each reply message is designated by any one or combination of the following: title, brief description, date recorded, time recorded and composer. At step 57, the dispatcher selects an appropriate message and the dispatcher system 1 forwards it to the appropriate field agent. This is done by going through steps 31-44 of FIG. 3a. The MIN extraction step 31 is slightly different in this process in that the MIN is provided to the dispatcher system 1 via Automatic Number Identification (ANI) as will be described later.

If at step 55, the dispatcher decides to generate his own message, he may record it and forward it to the appropriate field agent by going through steps 24-44 of FIG. 3a. Again, a first difference with generating a dispatcher outgoing message and replying to field agent's message is that the field agent's MIN will be provided to the dispatcher system 1 via ANI.

Another important difference between dispatcher originated messages and reply messages is the data being manipulated. For instance, dispatcher outgoing messages are stored and maintained separately from the incoming and reply messages, 8b and 8e, respectively.

IV. Dispatcher System Receives Messages

FIG. 4 shows steps for receiving a message at the dispatcher system 1 from a field agent's mobile communication device.

At step 61, the field agent pushes a button or a series of keys on a keypad which are used to dial-up the dispatcher system 1. At step 62, the mobile communication device records the field agent's message. After recording, the field agent pushes a button or a series of keys on a keypad on the mobile communications device to end the recording. The mobile communication device then attempts to establish a communications link between itself and the dispatcher system 1 via the PSTN 2 and wireless service provider 4 or 5 at step 63.

At step 64, the mobile communication device determines if a link has been established with the dispatcher system 1. If a link has not been established, perhaps due to the dispatcher system 1 receiving another message at that time, the mobile communications device waits an amount of time, either set at the time the device is manufactured or determined by the field agent entering a delay time at step 65, and then attempts to establish a communications link again at step 63.

If the mobile communications device determines that a communications link has been established at step 64, the PSTN 2 and appropriate wireless service 4 or 5 forwards the field agent's MIN by the use of Automatic Number Identification (ANI) at step 66. This is performed so the dispatcher system 1 knows where to send any reply message. Additionally, the MIN which is forwarded to the dispatcher system 1 may be used to search through the MIN/Name table 8c so that the incoming message display will have both the MIN of the incoming message and the name of the field agent who left the message. After the MIN has been forwarded to the dispatcher system 1, the mobile communications device transmits the field agent's message via the appropriate wireless service provider 4 or 5 and the PSTN 2 to the dispatcher system 1 at step 67. The dispatcher system 1 stores the message in the incoming messages memory section 8b at step 68.

At step 69, the dispatcher system 1 uses the received filed agent's MIN to derive the field agent's name. This is done by querying the MIN/Name table 8c using the MIN as a key. If the field agent's name is in the MIN/Name table, the query will return the field agent's name so that it may be displayed in the incoming messages display (see description of FIG. 3b). If field agent's name is not in the MIN/Name table 8c, the dispatcher system 1 displays a default value such as “Unknown” in the appropriate field of the incoming messages display.

Once the dispatcher system 1 has received the field agent's message, it transmits a “Delivery Complete” signal to the mobile communications device indicating that it has received the message at step 70. In response to receiving the “Delivery Complete” signal at step 71, the mobile communication device cancels the communication link it has with the dispatcher system at step 72.

The dispatcher system 1 then alerts the dispatcher via an audio alert signal to the speakers 10, a video alert signal to the monitor 13 or both at step 73 that informs the dispatcher that he has just received a message. The dispatcher system 1 then returns to the main menu state at step 74 and waits for an input from the dispatcher.

V. Dispatcher System Exits The Main Menu State

Typically, the dispatcher system originates all activity from a main menu as represented in FIG. 5. The main menu lists the possibilities of operations a dispatcher may perform. For instance, to send a message (FIG. 3a) the dispatcher selects the “Send Message” option from the main menu 80 of FIG. 5. Also, to view the incoming messages, perhaps in response to the “Alert Dispatcher” action taken in step 73, the dispatcher selects the “View Incoming Messages” option from the main menu 80.

Beyond these operations, the dispatcher may modify data within specific areas. For example, the dispatcher may compose a new outgoing message or reply message to be saved for later implementation by selecting either the “Compose Outgoing Message” or “Compose Reply Message” options. Once invoked, the recording and storing of the messages is similar to the process described in conjunction with FIG. 3a and will therefore not be repeated. In addition, the dispatcher may view a display listing of all outgoing and reply messages and delete those which are obsolete.

In addition, the dispatcher may also update the MIN/Name data table 8c by selecting the “Add/Delete Field Agents” options. In this operation, the dispatcher is prompted to enter the phone number (MIN) and the name of a field agent he wishes to add to the list. In addition, the dispatcher may delete field agents or update the table by providing an existing field agent with a new telephone number.

The final option allows the dispatcher to view the plurality of messages stored. By first selecting the option to view messages, the dispatcher is then prompted to select which type of messages (i.e. outgoing, reply and archived incoming) he wishes to view. After that, the user may select to replay any particular message or delete it. In addition, the dispatcher may move or copy one message from one location to another. This situation occurs when a field agent sends an important reply to the dispatcher system 1 which answers particular needs of other field agents. In such a situation, the reply message of the first field agent is transferred to an outgoing message to the other field agents.

While the above examples and descriptions have been provided for ease of understanding, they should not be construed to limit the invention as set forth in the appended claims. Obvious variations and modifications to one of ordinary skill in the art are within the scope of the present invention. For example, while various data blocks within the memory are shown as discrete blocks, it is also envisioned by this invention that a memory system which interleaves the various type of data for efficiency is possible.

In addition, the display which list all of the messages the dispatcher system has can be ranked in the order in which they are received, by their respective MINs from the mobile communications device which transmitted the message, composer or title. In any format, the listing presents to the dispatcher which messages he has in his particular memory section. The incoming messages display may also have indicators associated with each message which indicate whether the dispatcher has listened to the message or replied to the message. Deleted messages will not be shown on most displays although they may be shown in a deleted menu which holds all files to be deleted by the dispatcher upon shutting-off the dispatcher system.

It should also be obvious to one of ordinary skill in the art to rearrange the order of the steps presented in FIGS. 3a-5 without departing from the scope of the invention. For instance, in FIG. 3a, the dispatcher's message is described to be recorded before it is forwarded to the field agents. It is within the scope of this invention to rearrange these steps such that the message is forwarded to the field agents before it is saved by the dispatcher.

Additionally, the present invention is not limited to voice messages. Data and email messages may be processed in a similar manner. The present invention is also not necessarily limited to the users using wireless communications devices. A user may have access to a land-lined phone and use it to receive dispatcher messages via the land-line.

Additionally, FIG. 2 has been shown with a clock being discrete from the CPU. It is within the scope of this invention to have a CPU with an on-chip clock. Also, while the bus 18 has been shown as one bus, it should be understood that other bus structures, such as a plurality of interconnected sub-buses, is contemplated.

What is claimed is:

1. A system for dispatching a message comprising:
a memory for storing the message;
an interface coupled to a network;
a message unit for controlling the construction of the message stored in the memory; and
wherein the message stored in the memory is forwarded onto the network in a wireless protocol format via the interface.

2. The system for dispatching messages of claim 1 further comprising:
a mail unit that includes an acoustic recording unit; and wherein
the network is a telephone network, and;
the wireless protocol format corresponds to a format accepted by a mobile communication device.

3. The system for dispatching messages of claim 2 wherein:
the mobile communication device transmits an incoming message into the memory.

4. The system for dispatching messages of claim 3 comprising:
a monitor that transmits a first signal indicating when the incoming message from the mobile communication unit has been forwarded into the memory.

5. The system for dispatching messages of claim 3 comprising:
at least one speaker that transmits a first signal indicating when the incoming message from the mobile communication unit has been forwarded into the memory.

6. The system for dispatching message of claim 3 comprising:
a monitor that transmits a first signal to a dispatcher indicating when the incoming message from the mobile communication unit has been forwarded into the memory; and
at least one speaker that transmits a second signal indicating when the incoming message from the mobile communication unit has been forwarded into the memory.

7. The system for dispatching messages of claim 3 wherein:
the message unit is further comprised of a subroutine that controls the mail unit so that the mail unit playsback the messages within the memory over a pair of speakers.

8. The system for dispatching messages of claim 4 wherein:
the monitor transmits a second signal to the dispatcher indicating the mobile communication device has received one of the messages which is selected to be sent to it.

9. The system for dispatching messages of claim 5 wherein:
the at least one speaker transmits a second signal indicating the mobile communication device has received the message sent to it.

10. The system for dispatching messages of claim 6 wherein:
the monitor transmits a third signal indicating the mobile communication device has received the message sent to it; and
the at least one speaker transmits a fourth signal indicating the mobile communication device has received the message sent to it.

11. A method of dispatching a message from a central dispatching system comprising:
recording the message from a dispatcher;
storing the message in a memory;
establishing a first link between the central dispatching system and a mobile communication device; and
forwarding the message to the mobile communication device via the first link.

12. The method of dispatching the message from the central dispatching system of claim 11 further comprising:
transmitting a signal from the mobile communication device to the central dispatching system indicating the mobile communication device has received the message.

13. The method of dispatching the message from the central dispatching system of claim 11 further comprising:
replaying the message after the dispatcher has recorded it.

14. The method of dispatching the message from the central dispatching system of claim 11 further comprising:
recording an incoming message from a field agent;
establishing a second link between the mobile communication device and the central dispatching system;
forwarding the incoming message to the central dispatching system via the second established link; and
storing the incoming message in the memory.

15. The method of dispatching the message from the central dispatching system of claim 11 further comprising:
forwarding the message to another mobile communication device via a second link.

16. The method of dispatching the message from the central dispatching system of claim 15 wherein:
the order in which the mobile communication device and the other mobile communication device receive the message, respectively, is determined by the order in which the dispatcher selects the mobile communication device and the other mobile communication device and the availability of each mobile communication device to receive the message at the time the message is forwarded to each mobile communication device.

17. The method of dispatching the message from the central dispatching system of claim 11 further comprising:
wherein the dispatcher selects the mobile communication device from a list of mobile communication devices available to receive the message.

18. The method of dispatching the message from the central dispatching system of claim 17 further comprising:
wherein the dispatcher adds or deletes a selected available mobile communication device to/from the list of mobile communication devices.

19. The method of dispatching the message from the central dispatching system of claim 11 further comprising:
wherein the forwarding of the message to the mobile communication device is performed such that the message is forwarded in a format compatible with the mobile communication device.

20. A computer readable medium for controlling a system so the system's operations comprise:
recording an outgoing message from a dispatcher;
storing the outgoing message;
forwarding the outgoing message to a mobile communication device via a communication link.

21. The computer readable medium for controlling the system of claim 20 where the system's operation further comprises:
receiving a message from the mobile communication device.

22. The computer readable medium for controlling the system of claim 21 where the system's operation further comprises:
alerting the dispatcher upon reception of the message from the mobile communication device.

23. The computer readable medium for controlling the system of claim 21 where the system's operation further comprises
playing the message received from the mobile communication device.

24. The computer readable medium for controlling the system of claim 20 where the message is forwarded to more than one mobile communication device.

25. The computer readable medium for controlling the system of claim 21 where the message is forwarded in a format that is compatible with the mobile communication device.

26. The computer readable medium for controlling the system of claim 22 further comprising:
forwarding a reply message in response to the message received from the field agent's mobile communication device.

27. The computer readable medium for controlling the system of claim 26 wherein the forwarded message is a previously recorded reply message.

28. The computer readable medium for controlling the system of claim 26 wherein the forwarded message is a newly recorded reply message.

29. The computer readable medium for controlling the system of claim 21 wherein the message from the mobile communication device is saved.

30. The computer readable medium for controlling the system of claim 29 wherein the saved message from the mobile communication device is replayed.

31. The computer readable medium for controlling the system of claim 29 wherein the saved message from the mobile communication device is deleted.
